(19) United States
(12) Patent Application Publication
(10) Pub. No.: US 2010/0188509 A1
(43) Pub. Date: Jul. 29, 2010

(54) CENTRAL ACCESS CONTROL APPARATUS

(76) Inventor: IK HUH, Seoul (KR)

Correspondence Address: Hershkovitz & Associates, LLC, 2845 Duke Street, Alexandria, VA, 22314, US

(21) Appl. No.: 12/692,544

(22) Filed: Jan. 22, 2010

(30) Foreign Application Priority Data
Jan. 23, 2009 (KR) 10-2009-0006121

(51) Int. Cl. H04N 7/18; G05B 19/00; G06F 3/041

(52) U.S. Cl. 348/156; 340/5.2; 345/173; 348/E07.085

(57) ABSTRACT

Provided is a central access control apparatus in which a CPU board, an intermediate board and a touch panel board are integrally formed. The CPU board includes a memory chip that stores identification information, and a CPU chip that determines whether user information from a user corresponds to the identification information and controls the opening/closing of a door. The intermediate board includes a relay, a capacitor and a resistor. The touch panel board includes a touch panel that displays the user information and receives input information. Thus, the central access control apparatus prevents an unauthorized person from accessing thereto, making it possible to prevent identification information from being undesirably modified and leaked.

### CROSS-REFERENCE TO RELATED APPLICATION

This application claims priority to Korean Patent Application No. 10-2009-0006121 filed on Jan. 23, 2009 and all the benefits accruing therefrom under 35 U.S.C. §119, the contents of which are incorporated by reference in their entirety.

### BACKGROUND

The present disclosure relates to an access control system, and more particularly, to a central access control apparatus which does not require a separate administration computer and prevents unauthorized access to thereby enhance the security itself.

Due to recent developments in biometric identification technology using fingerprint, iris pattern, vein pattern, and other forms of biometric information, there is a sudden surge in demand for access control systems that use the technology to restrict access to secure areas. These access control systems can also use an RFID card, a barcode card and so on.

FIG. 1 is a schematic view illustrating a related access control system that is disclosed in U.S. Pat. No. 6,442,463.

Referring to FIG. 1, the access control system primarily includes a card reader 15, a door lock 16, a door 17, a controller 11, and an administration computer 35. The door lock 16 is installed at the door 17, and the card reader 15 is located next to the door 17.

The door lock 16 and the card reader 17 are electrically connected to the controller 11 in a central control center. The controller 17 receives user information from the card reader 15, and determines whether the user information corresponds to pre-stored identification information. If the input information corresponds to the identification information, the controller 11 provides an electrical signal to the door lock 16 to open the door 17. If not, the controller 11 may generate an alarm indication.

In other words, when a user presents an identification card or badge 19 to the card reader 15, the card reader 15 reads user information from the identification card or badge 19 and sends the user information to the controller 11.

The controller 11 is connected to the administration computer 35. A system administrator can perform updating, changing and deleting of the identification information in the controller 11 using the administration computer 35.

The door lock 16 may be connected to the controller 11 through internet network, local area network, or wireless communication network.

As described above, in order to enhance security and reliability of the access control system, focused investments are being made on identification process using biometric identification or other identification technologies. However, since the identification information in the controller 11 can be updated, changed, or deleted through the administration computer 35. Thus if an unauthorized person connects his/her notebook computer to the controller 11, the person can easily modify the identification information in the controller 11. Furthermore, when the administration computer is connected to internet network, the identification information can be modified by hackers.

Therefore, it is really needed to improve the security of a controller, and also to develop a compact and convenient controller for installation and use.

### SUMMARY

The present disclosure provides a central access control apparatus configured to control the opening/closing of a plurality of doors in a building, in which a CPU board, an intermediate board and a touch panel board are integrally formed, wherein the CPU board includes a memory chip that stores identification information, and a CPU chip that controls the opening/closing of a door, the intermediate board that includes a relay, a capacitor and a resistor in a peripheral portion thereof, and the touch panel board that includes a touch panel for displaying the user information and receiving input information.

In accordance with an exemplary embodiment, a central access control apparatus configured to control the opening/closing of a plurality of doors in a building, includes: a CPU board including IC chips; an intermediate board disposed on the CPU board, the intermediate board including a capacitor and a resistor except for the IC chips; and a touch panel board disposed on the intermediate board, the touch panel board including a touch panel that is configured to display the user information and receive input information; wherein the IC chips includes a memory chip that is configured to store each identification information corresponding to each of the plurality of doors, and a CPU chip that is configured to determine whether user information from a user corresponds to the identification information and control the opening/closing of the door, wherein the touch panel board is electrically connected to the intermediate board through a socket connection, the intermediate board is electrically connected to the CPU board through a socket connection, the capacitor and the resistor are disposed at a peripheral portion of the intermediate board, and the touch panel board is disposed on a central portion of the intermediate board.

The central access control apparatus may further include a case with a door cover that receives the CPU board, the intermediate board, and the touch panel board to prevent from an unauthorized access.

The case includes a sensor that senses the opening/closing of the cover thereof.

At least one of the CPU board, the intermediate board, and the touch panel board includes a camera that is actuated according to a signal from the sensor.

The central access control apparatus may further include a case with an opening that is configured to expose the touch panel board.

At least one of the CPU board, intermediate board, and touch panel board includes a camera, and the case includes another opening to expose the camera, and the camera is actuated when the touch panel is turned on.

### BRIEF DESCRIPTION OF THE DRAWINGS

Exemplary embodiments can be understood in more detail from the following description taken in conjunction with the accompanying drawings, in which:

FIG. 1 is a schematic view illustrating a related access control system;

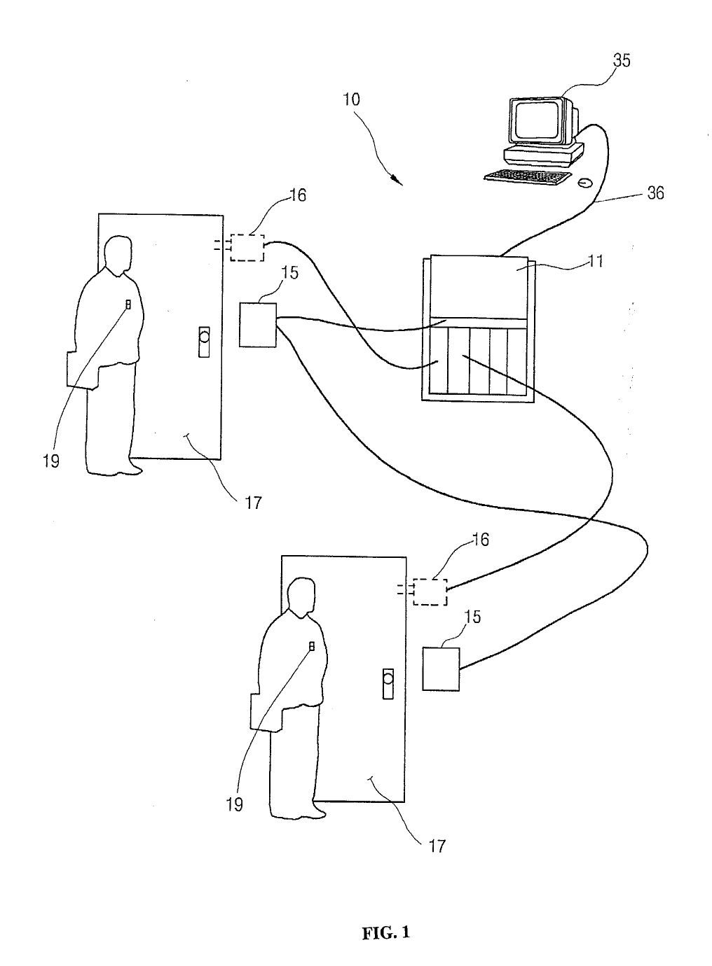

FIG. 2 is a schematic view illustrating a CPU board of a central access control apparatus in accordance with an exemplary embodiment;

FIG. 3 is a schematic view illustrating an intermediate board of a central access control apparatus in accordance with another exemplary embodiment;

FIG. 4 is a schematic view illustrating a coupled state between an intermediate board and a touch panel board of a central control apparatus in accordance with an exemplary embodiment;

FIG. 5 is a schematic view illustrating a central access control apparatus in a case in accordance with an exemplary embodiment; and

FIG. 6 is a schematic view illustrating a central access control apparatus in a case in accordance with another exemplary embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

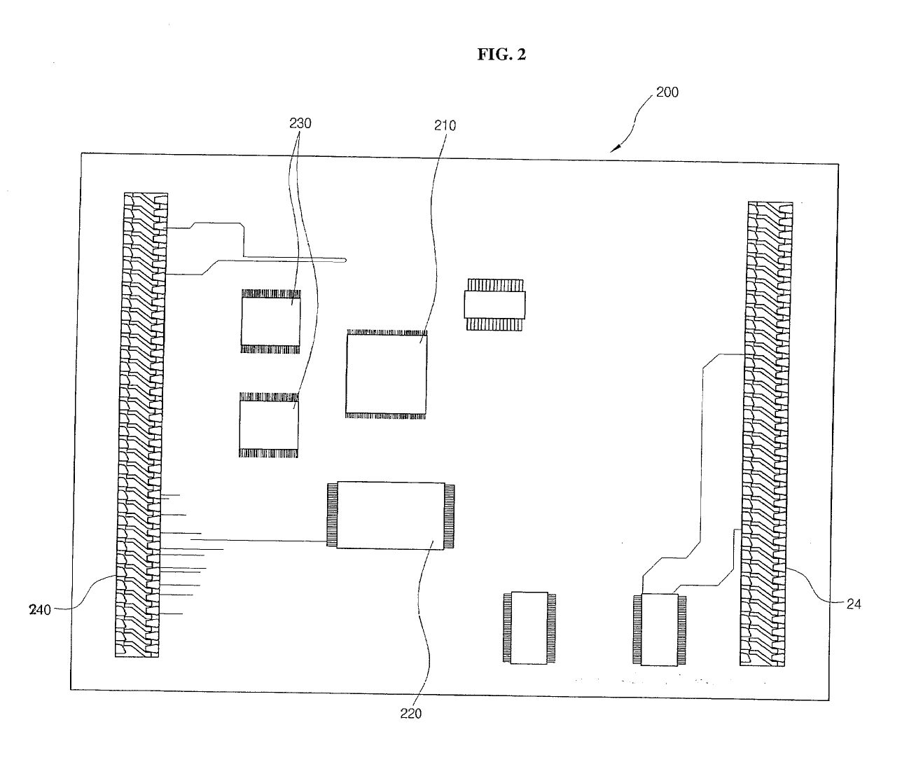

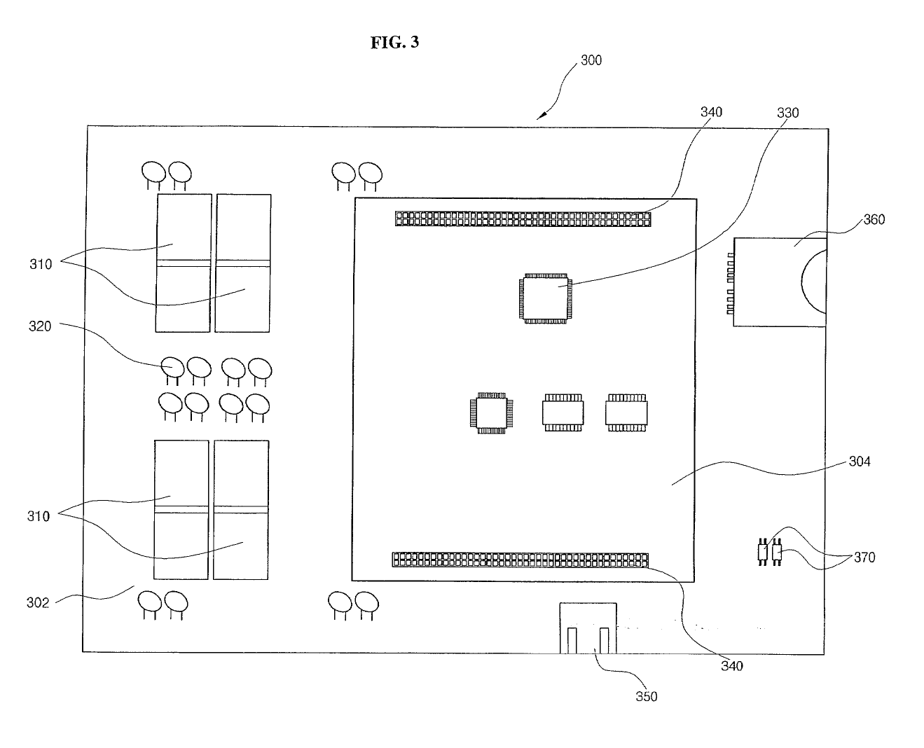

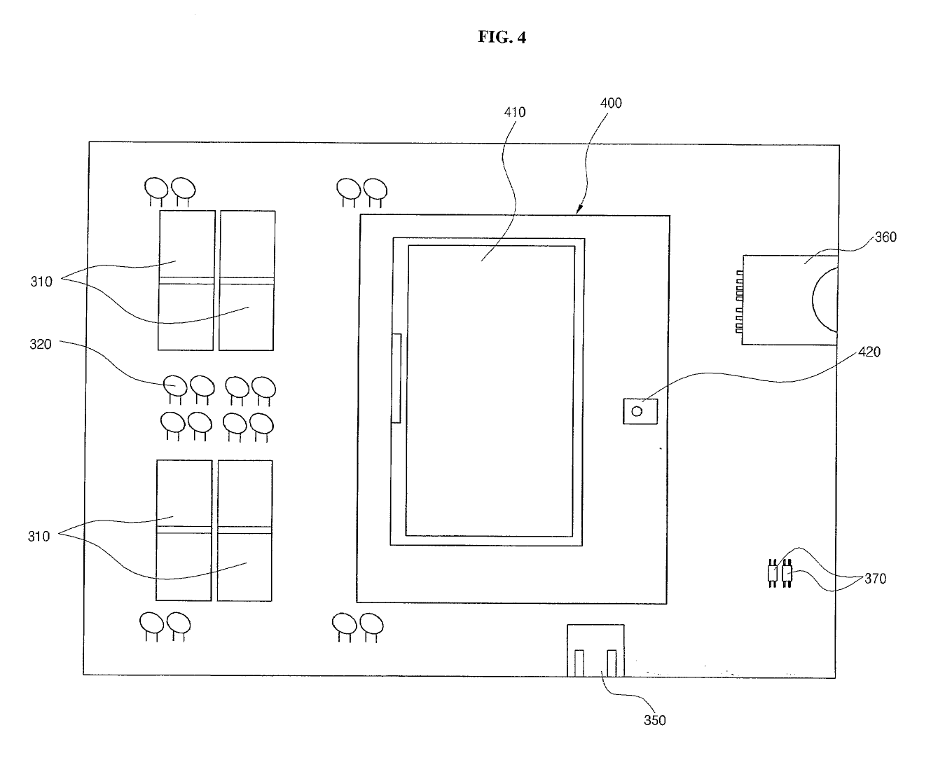

FIGS. 2 and 3 are schematic views illustrating a CPU board and an intermediate board of a central access control apparatus respectively in accordance with an exemplary embodiment. FIG. 4 is a schematic view illustrating a coupled state between the intermediate board and a touch panel board of the central access control apparatus.

Referring to FIGS. 2 to 4, a central access control apparatus in accordance with an exemplary embodiment includes a CPU board 200, an intermediate board 300, and a touch panel board 400.

Referring to FIG. 2, the CPU board 200 includes IC chips such as a CPU chip 210 as a central processing unit and a memory chip 220.

The CPU chip 210 may be a 32 bit CPU chip. The CPU chip 210 receives user information transmitted through an information acquisition unit (not shown) such as an RFID reader, a barcode reader, or a biometric information reader located next to a locked door (not shown), and determines whether the user information corresponds to identification information stored in the memory chip 220. If the user information corresponds to the identification information, the CPU chip 210 generates an open signal and transmits it to open the locked door. If not, the CPU chip 210 may store the user information in the memory chip 220 and generate an alarm.

The memory chip 220 may be a readable and writable memory unit. The memory chip 220 may store identification information required to open the locked door and user information from the information acquisition unit. The user information includes biometric information, such as fingerprint, iris pattern and vein pattern, user identification code, name, age, sex. In order to increase storage capability, a flash memory chip 230 may be installed at the CPU board 200.

Socket connections 240 are disposed at both side of the CPU board 200 for electrically connecting the CPU board 200 and the intermediate board 300 to each other.

The CPU board 200 includes main chips such as the CPU chip 210, the memory chip 220 and the flash memory chip 320. Because the main chips have thin thickness, though the CPU board 200 is coupled to the intermediate board 300, the total thickness is relatively small.

Referring to FIG. 3, the intermediate board 300 is divided into a central portion 304 and a peripheral portion 302. The touch panel board 400 is disposed at the central portion 304, and a relay 310, a capacitor 320 and a resistor 370 are arranged at the peripheral portion 302.

Because the relay 310, the capacitor 320 and the resistor 370 have thick thickness, if the touch panel board 400 is disposed on them, the total thickness is undesirably increased. On the other hand, if the intermediate board 300 becomes larger to provide space for the touch panel board 400, the total thickness is reduced. However the entire size of the central access control apparatus is greatly increased.

Thus, the relay 310, the capacitor 320 and the resistor 370 except for IC chips are arraigned on the peripheral portion 302. In addition, a POE (Power of Ethernet) controller 330 may be mounted in the central portion 304 since the POE controller 330 is formed in chip shape. Thus, when the touch panel board 400 is disposed on the central portion 304, the total thickness is still small.

Sockets connections 340 are installed at both side of the central portion 304 for electrically connecting the touch panel board 400 to the intermediate board 300.

A POE port 350 for automatic power supply is provided at an edge of the intermediate board 300. A connection port 360 for a detachable memory card is provided at another edge thereof, and thus a system administrator may back up, to the detachable memory card, information stored in the memory chip 220. The detachable memory card may be a SD or USB memory card.

Referring to FIG. 4, the touch panel board 400 includes a touch panel 410. In order to compact the central access control apparatus, the touch panel 410 may be a thin touch panel such as an LCD touch panel or an OLED touch panel. In addition, many different types of touch sensing technologies may be used in the touch panel 410, including capacitive, resistive, infrared, and surface ultrasonic wave types.

A system administrator can update, change, delete or output information stored in the memory chip 220 through the touch panel 410. Thus, an administration computer is not needed for performing updating information stored in the memory chip 220 and other functions.

The touch panel board 400 is provided with a camera 420 to indentify an operator who is using the touch panel 410. While the camera 420 may be installed on the CPU board 200, the intermediate board 300, or the touch panel board 400, it is desirable that the camera 420 is installed at the touch panel board 400 that is the uppermost board of these boards 200, 300, 400.

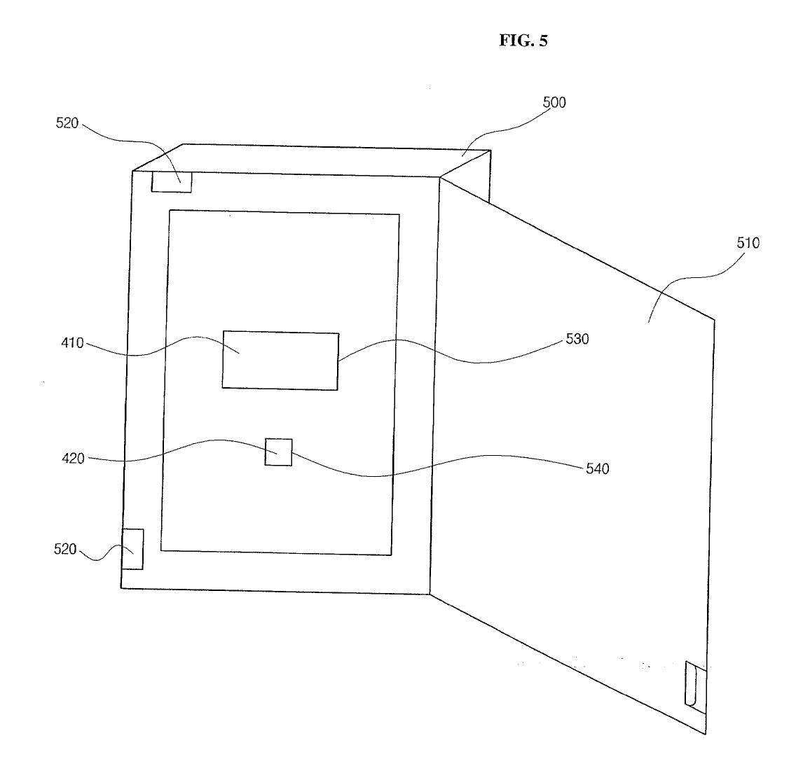

FIG. 5 is a schematic view illustrating the central access control apparatus in a case in accordance with an exemplary embodiment.

Referring to FIG. 5, the CPU board 200, the intermediate 300, and the touch panel board 400 are received in a case 500 to prevent access by an unauthorized person.

As described above, because the central access control apparatus is not connected to an administration computer and received in the case 500 to prevent access from an unauthorized person, the security of the central access control apparatus is greatly enhanced.

When a system administrator needs, for example, to update the identification information in the memory chip 220, the administrator can release a lock 520 installed at the case 500 to open a door cover 510 of thereof and update the identification information though the touch panel 410.

In addition, the case 500 is provided with a sensor 520 for sensing the opening/closing of the cover 510, and the sensor 520 is linked to the camera 420. Thus, when the sensor 520 senses the opening of the cover 510, the camera 420 is turned on to capture the image of an operator, and when the sensor 520 senses the closing of the cover 510, the camera 420 is turned off. Consequently, by capturing the image of the operator, the security of the central access control apparatus is further improved.

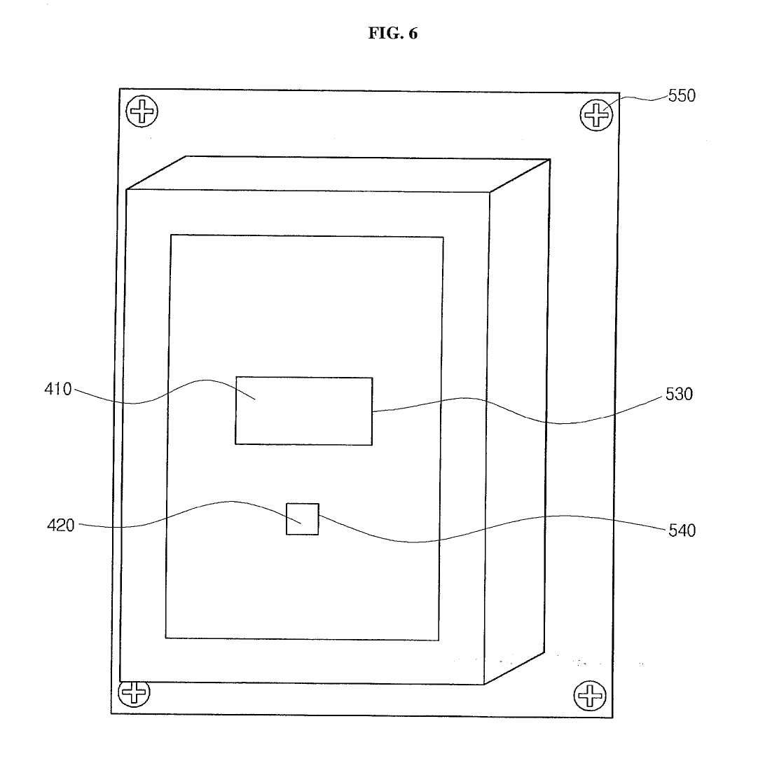

FIG. 6 is a schematic view illustrating a coupled state between the central access control apparatus and another case in accordance with another exemplary embodiment.

Referring to FIG. 6, there is no a door cover in a case 600 unlike the case 500 in FIG. 5. The case 600 may be attached to a wall through a coupling member such as bolts 550. The case 600 includes a touch panel opening 530 for exposing the touch panel 410, and a camera opening for exposing the camera 420.

The touch panel 410 is configured to be turned on when an operator touches the touch panel 410, and to request administration password. If there is no touch for some time, the touch panel 410 is turned off.

Also, the touch panel 410 is linked to the camera 420. Thus, when the touch panel 410 is turned on, the camera 420 is also turned on, and when the touch panel 410 is turned off, the camera 420 is also turned off.

In the central access control apparatus disclosed in the exemplary embodiments, the CPU board 200, the intermediate board 300, and the touch panel board 400 are integrally formed. In other words, without an administration computer, a system administrator can update, change, or delete information in the memory chip 220 using the touch panel 410.

In order to construct an access control system in a building, a wire network should be installed for communication between the central access control apparatus and each of door locks. However, boring holes in ceilings and walls is needed to install the wire network without compromising the building. As a result, a lot of time and costs may be required for the installation.

To overcome this limitation, an internet network may be used for the communication. Generally, an internet network is already provided in buildings. Thus, the central access control apparatus can communicate with door looks by using the internet network without the wire network installation. The internet network may be a wire or wireless internet network.

Specifically, the central access control apparatus may be provided with an internet port, so it is possible to performing communication using the internet network. An internet port is also installed at each data reader and door lock that is installed next to each door, making it possible to communicate between each data reader and door lock with the central access control apparatus through the internet network. The data reader receives user information through a biometric information reader, a RFID reader, a barcode reader.

Furthermore, if a wireless internet module is installed in the central access control apparatus, the data reader and the door lock, they are communicated with each other through a wireless internet network. Thus, without the installation of the wire network, the access control system can be constructed in the building.

Although the central access control apparatus has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A central access control apparatus configured to control the opening/closing of a plurality of doors in a building, comprising:
a CPU board comprising IC chips;
an intermediate board disposed on the CPU board, the intermediate board comprising a capacitor and a resistor except for the IC chips; and
a touch panel board disposed on the intermediate board, the touch panel board comprising a touch panel that is configured to display the user information and receive input information;
wherein the IC chips comprises a memory chip that is configured to store each identification information corresponding to each of the plurality of doors, and a CPU chip that is configured to determine whether user information from a user corresponds to the identification information and control the opening/closing of the door,
wherein the touch panel board is electrically connected to the intermediate board through a socket connection, the intermediate board is electrically connected to the CPU board through a socket connection, the capacitor and the resistor are disposed at a peripheral portion of the intermediate board, and the touch panel board is disposed on a central portion of the intermediate board.

2. The apparatus of claim 1, further comprising a case with a door cover that receives the CPU board, the intermediate board, and the touch panel board to prevent from an unauthorized access.

3. The apparatus of claim 2, wherein the case comprises a sensor that senses the opening/closing of the cover thereof.

4. The apparatus of claim 3, wherein at least one of the CPU board, the intermediate board, and the touch panel board comprises a camera that is actuated according to a signal from the sensor.

5. The apparatus of claim 1, further comprising a case with an opening that is configured to expose the touch panel board.

6. The apparatus of claim 5, wherein at least one of the CPU board, intermediate board, and touch panel board comprises a camera, and the case includes another opening to expose the camera, and the camera is actuated when the touch panel is turned on.
